(19) United States
(12) Patent Application Publication
(10) Pub. No.: US 2024/0015862 A1
(43) Pub. Date: Jan. 11, 2024

(54) Microwave Thawing Process for Salmon

(71) Applicant: AQUACHILE INC., Miami, FL (US)

(72) Inventors: Neruxy Márquez, Castro (CL); Rodrigo Díaz, Puerto Varas (CL); Juan Carlos Carreño, Comuna Rengo (CL)

(21) Appl. No.: 17/859,386

(22) Filed: Jul. 7, 2022

(51) Int. Cl. H05B 6/78

(52) U.S. Cl. CPC H05B 6/782

(57) ABSTRACT

Provided is a continuous process to thaw salmon, by means of microwaves, where the salmon, once thawed, maintains its organoleptic, physical and biochemical characteristics, identical or superior to that of fresh salmon, obtaining a temperature in its thermal center of between 26.60 to 30.20° F. (−3° C. to −1° C.). The process is carried out in a thawing tunnel that has an entrance and an exit, between which a conveyor belt is located, on which are deposited the boxes. The process includes the steps of (a) place said boxes into the tunnel at an initial temperature between 3.2 to 12.20° F. (−16° C. and −11° C.); (b) advance said boxes towards the interior of the tunnel at a speed between 1,800 and 2,500 mm/min; (c) irradiating the boxes with microwaves at a power of between 35 to 70 Kilowatts for 1.5 to 2.4 minutes.

### BACKGROUND OF THE INVENTION

### Field of Invention

The present invention relates to a microwave thawing process for salmon, salmon fillets and gutted whole salmon, which makes it possible to obtain a product with organoleptic, physical and biochemical characteristics identical to or superior to fresh salmon. More specifically, the present invention relates to a microwave thawing process for salmon fillets and gutted whole salmon, for subsequent processing, distribution and sale as a fresh thawed product.

### Description of Related Art

During the year 2021 the supply of salmon worldwide exceeded 5 million wfe tons (5.002.000). One of the most important segments in the marketing of this product is fresh salmon. However, as it is a product that is marketed/distributed throughout the world, salmon exporting companies, once they have been processed, must freeze them in order to reach the different markets globally.

Freezing is a common method for preserving salmon fillets and gutted whole salmon, as it stops chemical and microbiological degradation, while also preserving organoleptic, physical and biochemical attributes.

However, to obtain a fresh product again, it is necessary to carry out a thawing process. There are three basic ways of transferring heat or energy in the form of heat (heat exchange phenomena);

1. The conduction or transfer of energy in the form of heat by conduction is a process of heat transmission based on direct contact between bodies, without exchange of matter, where heat flows from a body of higher temperature to another of lower temperature. temperature that is in contact with the first.

2. Convection or transfer of energy in the form of heat by convection occurs only by means of materials, the evaporation of water or fluids. Convection itself is the transport of heat by means of fluid motion. Convection can be external or internal. When it is external then the fluid moves on the surfaces and if it is internal then it moves inside the surfaces. In this way convection is the transfer of heat from one place to another by the movement of fluids. In the absence of an internal source, when the fluid is in contact with a hot surface, its molecules separate and spread out, making the fluid less dense. As a consequence, the fluid is displaced while the cooler fluid becomes denser and the fluid sinks. Therefore, the hotter volume transfers heat to the cooler volume of that fluid. Familiar examples are the upward flow of air due to a fire or hot object, and the circulation of water in a pot that is heated from below.

3. Thermal radiation or heat radiation is heat or energy transfer in the form of heat emitted by a body due to its temperature. This radiation is electromagnetic radiation that is generated by the thermal movement of charged particles in matter. Due to this effect, all bodies emit electromagnetic radiation, its intensity depending on the temperature and the wavelength considered. Thermal radiation is one of the fundamental mechanisms of heat transfer.

The microwaves make the water molecules vibrate, they make them rotate quickly from one side to the other, at a very high speed and, in this fast turning movement, the water molecules collide with those in their surroundings and produce energy, but disorderly, which produces an increase in temperature. The moisture contained in the food and that is subjected to microwave radiation causes it to heat up and, therefore, it is one of the tools used for defrosting.

Hence, today the methods used in the industry to thaw salmon are:

1. Cold room: One of the known thawing processes is the one carried out in a cold room, this process being one of the most common methods. Frozen foods are stored in a chamber at a temperature of about 39.20° F. (4° C.) with air circulation, until they slowly reach room temperature. However, this simple solution has several drawbacks: the defrosting time can last up to 48 hours, the result is not always homogeneous, but above all there is significant dripping of water with juice from the product.

2. Cold Water: Another of the known defrosting processes is through the use of cold water. This method is faster than thawing in a cold room, but requires more care. Food must be in an airtight container or plastic bag. If the bag leaks, bacteria in the water can contaminate food. In addition, the meat tissue can absorb water, leading to a watery product.

3. Rotating Drum: Additionally, there is a defrosting process that uses a rotating drum, whose walls are slightly heated. In some cases, cold steam is added under vacuum to improve the result of the process. This solution is faster than thawing a cold room, taking hours instead of days. One of the disadvantages of this process is that it is not continuous, so it is not really suitable for processing large quantities of food and is not at all suitable for delicate products such as fruits, vegetables and fish meat, for example. Salmon.

4. Microwaves and Radiofrequency: Another of the thawing processes is the one carried out using microwaves and radiofrequency. Microwaves and radiofrequency have the property of defrosting the entire mass of a product quickly. Unlike other solutions, where heat is transferred by conduction from the surface of the food to its core, the waves pass through the entire block of food. The speed of this type of process prevents drip loss or bacterial growth. Microwave or radio frequency thawing takes 3-20 minutes instead of hours or days with traditional methods, even for large blocks of food. This technology is even suitable for sensitive products such as fruits, vegetables and fish meat, such as salmon. However, the application by radiofrequency is not always entirely adequate, given that it is possible that the salmon not only thaws, but also has cooking zones, as can be seen in FIGS. 1 to 3. To this type of problem, the loss of organoleptic, physical and biochemical characteristics is also added, with which thawed salmon does not resemble fresh salmon.

Likewise, within the previous state of the art various methods of defrosting different types of meat products are disclosed. In a search of the state of the art, the closest patent documents found were the following: document CN107950633 discloses a defrosting method for sausages. The thawing method comprises the following steps of (a) rapidly removing the required sausages from the freezing environment which is at a temperature in the range of −58.00 to −76.00° F. (−50° to −60° C.); (b) placing the sausages in unfrozen fluid for soaking for a time range of 50 to 90 seconds; (c) placing the soaked sausages in a container capable of being subjected to microwave operation; and (d) putting said container in a microwave oven at a power of between 280 to 350 Watts for 4 to 8 minutes. The thawing method disclosed in this document has the advantages of being simple in technology, easy to operate, low in maintenance cost. In addition, thawed products have significant effects in maintaining texture and color, reducing the number of microorganisms. This method is suitable for processing and defrosting sausages of different kinds, including sausages with fish meat.

On the other hand, document JP2008206507 discloses an underwater defrosting machine that has a tank containing a solution of water and ethyl alcohol, where the water treatment is carried out with a recirculation system that passes through a UV lamp. with germicidal action. The machine uses a piezoelectric vibration element that produces a wave that is around 1,600 kHz to 2,600 kHz or similar, to lower the temperature from −49.00 to 28.40° F. (−45° C. to −2° C.), producing waves that generate friction in the water molecules. The times to thaw the product in general are in a range of to 10 minutes. For products of a reduced size, the wave application time is 2 to 3 minutes.

Document JP2015116148 discloses a room for defrosting a frozen product, such as tuna. The product thaws in a short time at a temperature between 23.00 to 32.00° F. (−5° C. and 0° C.). The room has a thawing equipment that has a storage chamber that stores the product to be thawed. The equipment has a temperature control means inside the chamber and an electrode to generate an electric field in the position where the product is placed. The equipment has a control element that applies a voltage to the electrode according to the conditions of shape and size of the product to be thawed.

JP2008271944 discloses an underwater thawing device, which has a thawing treatment tank, which is filled with water. The apparatus has an underwater ultrasonic vibrator configured to be attached to an inner face of the pond, which emits ultrasonic waves. Further, the apparatus comprises a sensor configured to detect the temperature inside the tank and a temperature adjuster configured to adjust the temperature of the thawing treatment water, and a controller configured to control the underwater ultrasonic vibrator. The apparatus has: a separation and retention means configured to separate and contain a material to be thawed, which is deposited inside the thawing treatment tank, and a plurality of underwater ultrasonic vibrators that emit frequencies in a range between 25 kHz to 300 kHz and in a range between 300 kHz. at 2000 kHz.

In general, all microwave thawing equipment and processes result in rapid product thawing. However, not all deliver a result in which the thawed salmon has organoleptic, physical and biochemical characteristics identical to or superior to fresh salmon.

In accordance with the foregoing, a first objective of the present invention is to generate a salmon thawing process that is fast and continuous, in such a way that it allows large quantities of salmon meat to be thawed.

A second objective of this invention is to obtain salmon fillets and gutted whole salmon, which maintain organoleptic, physical and biochemical characteristics identical to or superior to fresh salmon meat, once they have been subjected to a thawing process.

A third objective of the present invention is to obtain a thawing product of salmon fillets and gutted whole salmon that has a thermal center between 26.60 to 30.20° F. (−3° C. to −1° C.).

### SUMMARY OF THE INVENTION

The present invention relates to a continuous microwave thawing process for salmon, salmon fillets and gutted whole salmon, which makes it possible to obtain a product with organoleptic, physical and biochemical characteristics identical or similar to salmon meat in the fresh state. More specifically, the present invention relates to a microwave thawing process for salmon, salmon fillets and whole salmon, for subsequent processing, distribution and sale to the market as fresh salmon meat, where the thermal center of the product reaches a temperature between 26.60 to 30.20° F. (−3° C. to −1° C.).

In the processing of salmon in plants, at the end of the production line, whole salmon or salmon fillets are obtained. Both whole salmon and salmon fillets are packed in boxes and subjected to a freezing process, where the packaged product reaches a temperature of between −40.00 to −22° F. (−40° C. to −30° C.) and, in its thermal center, it reaches a temperature of −0.40° F. (−18° C.). This packaged product is taken to cold stores to maintain the freezing temperature, awaiting dispatch to the distribution centers.

This packaged and frozen product is transported to the distribution areas, where the salmon is thawed, reaching a thermal center temperature of between 26.60 to (−3° C. to −1° C.), leaving the product ready to be marketed or kept in chambers at 32° F. (0° C.).

For the purposes of carrying out the present invention, the salmon must be packed in boxes of between 22 and 66 lbs. (10 and 30 kg).

The thawing process is carried out in a thawing tunnel that has an entrance and an exit, said tunnel having at least one microwave emitter and in whose lower interior part there is a conveyor belt that transports the boxes with the product in its inside.

According to this process, a box weighing between 22 and 66 lbs. (10 and kg) of product to be defrosted enters the defrosting tunnel through the entrance and onto the conveyor belt. The boxes enter the tunnel with an initial temperature between 3.2 to 12.20° F. (−16° C. and −11° C.), beginning their journey or advance at a speed of between 1,800 and 2,500 mm/min and, during their journey on the conveyor belt, they are irradiated with microwaves at a power of between 35 to 70 Kilowatts for 1.7 to 2.4 minutes. Upon reaching the tunnel exit, the boxes have a final temperature of between 26.60 to 30.20° F. (−3° C. to −1° C.), which corresponds to the temperature of the final center of the product.

The superior effects of the present process with respect to the prior art processes carried out by the Applicant will be shown in detail in the description of the invention that follows.

### BRIEF DESCRIPTION OF DRAWINGS

The patent or application file contains at least one drawing executed in color. Copies of this patent or patent application publication with color drawing(s) will be provided by the Office upon request and payment of the necessary fee.

The accompanying drawings are included to provide a greater understanding of the invention and constitute a part of this description and show one of the preferred executions.

FIG. 1 corresponds to a photograph that shows two cooking zones of a whole salmon when it is subjected to a radiofrequency thawing process.

FIG. 2 corresponds to a photograph that shows three cooking zones for salmon fillets when they are subjected to a radiofrequency defrosting process.

FIG. 3 corresponds to a photograph showing two cooking zones for salmon fillets when they are subjected to a radiofrequency defrosting process.

FIG. 4 shows a perspective view of a thawing tunnel, said tunnel having a conveyor belt inside, which allows the transit of packages or boxes with salmon.

FIG. 5 shows a cross-sectional perspective view of a thawing tunnel, said tunnel having a conveyor belt inside, which allows the transit of packages or boxes with salmon.

FIG. 6 shows a cross-sectional perspective view of a thawing tunnel, said tunnel having a conveyor belt inside, in which a package or box with salmon enters the tunnel, to begin its journey through the microwaves.

FIG. 7 shows a cross-sectional perspective view of a thawing tunnel, said tunnel having a conveyor belt inside, in which a package or box with salmon leaves the tunnel, to finish its passage through the microwaves.

FIG. 8 shows a ruler with the Salmofan® salmon color scale.

FIG. 9 is a graph showing the comparative results of the mesophilic aerobic count in Colony Forming Unit per gram of product (CFU/g) for skin-on salmon fillets from the prior art processes and the process of the present invention.

FIG. 10 is a graph showing the comparative results of the mesophilic aerobic count in Colony Forming Unit per gram of product (CFU/g) for skin-on salmon fillets from the prior art processes and the process of the present invention.

FIG. 11 is a graph showing the comparative results of mesophilic aerobic count in Colony Forming Unit per gram of product (CFU/g) for fresh skinless salmon fillets from the prior art processes and the process of the present invention.

FIG. 12 is a graph showing the comparative results of dynamic shrinkage for 4-5 Lb. (1.81 to 2.26 kg) skin-on salmon fillets from the prior art processes and the process of the present invention.

FIG. 13 is a graph showing the comparative dynamic shrinkage results for 4-5 Lb. (1.81 to 2.26 kg) skin-on salmon fillets from the prior art processes and the process of the present invention.

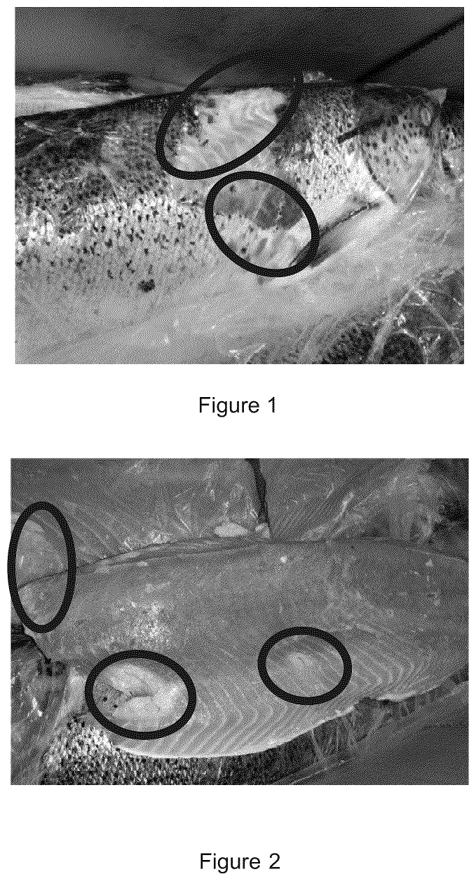

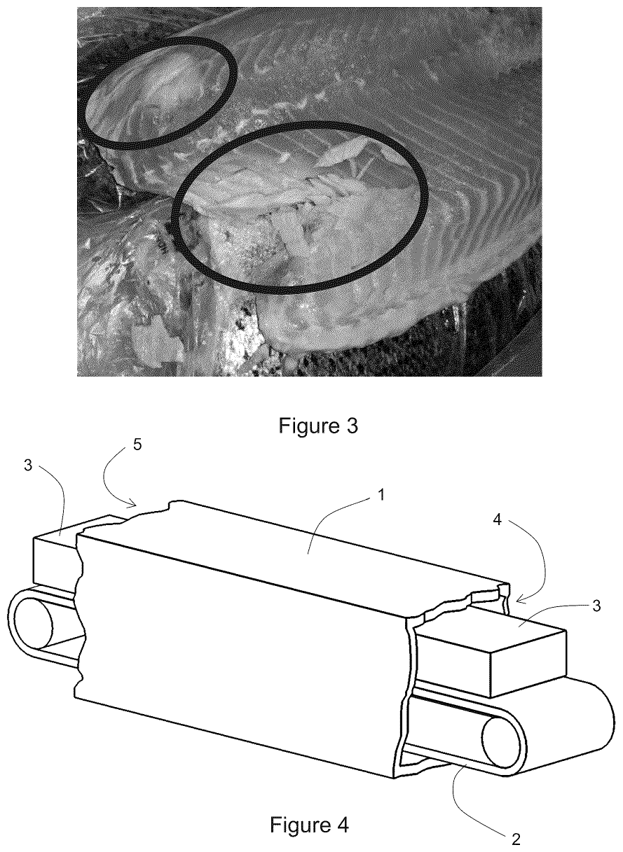

### DESCRIPTION OF THE INVENTION

The present invention relates to a microwave thawing process for salmon, salmon fillets and gutted whole salmon, which makes it possible to obtain a product with organoleptic, physical and biochemical characteristics identical to or superior to salmon meat in the fresh state. More specifically, the present invention relates to a microwave thawing process for salmon, salmon fillets and gutted whole salmon, for subsequent processing, distribution and sale to the market as fresh salmon meat, where the thermal center of the product reaches a temperature between 26.60 to 30.20° F. (−3° C. to −1° C.).

As noted above, salmon meat processing plants obtain whole salmon or gutted salmon fillets at the end of their production line. Both whole salmon and salmon fillets are packed in boxes and subjected to a freezing process, where the packaged product reaches a temperature of between −40.00 to −22° F. (−40° C. to −30° C.) and, in its thermal center, reaches a temperature of −0.40° F. (−18° C.). This packaged product is taken to cold stores to maintain the freezing temperature, awaiting the dispatch to the distribution centers.

This packaged and frozen product is transported to the distribution areas, where the salmon is thawed, reaching a thermal center temperature of between 26.60 to ° F. (−3° C. to −1° C.), leaving the product ready to be marketed.

In a preferred embodiment of the present invention, the salmon is packed in boxes that are in a range between 22 and 66 lbs. (10 and 30 kg).

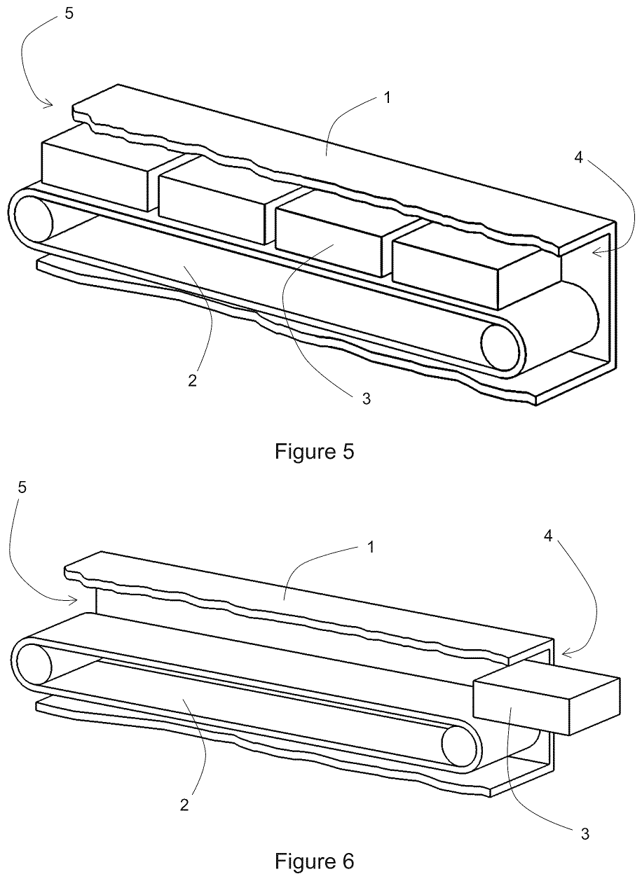

The thawing process is carried out in a thawing tunnel (1) that has an inlet (4) and an outlet (5), said tunnel (1) having at least one microwave emitter and in whose lower interior part is located a conveyor belt (2) that transports the boxes (3) with the product inside, as shown in FIGS. 4 and 5.

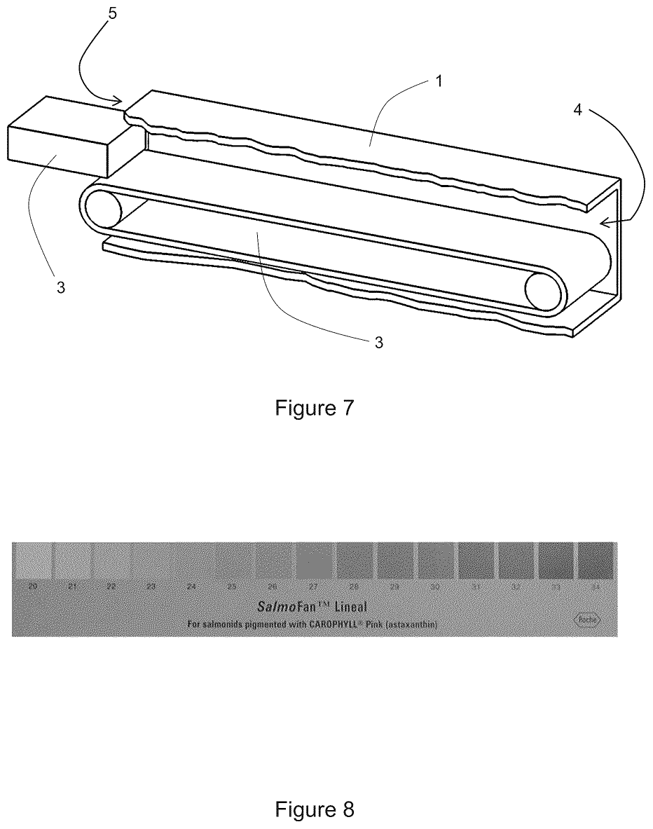

As exemplified in FIGS. 6 and 7, a box (3) weighing between 22 and 66 lbs. (10 and 30 kg) of product to be thawing enters the thawing tunnel (1) through the entrance (4) and on the conveyor belt (2). The boxes (3) enter the tunnel (1) with an initial temperature of between 3.2 to 12.20° F. (−16° C. and −11° C.), beginning their displacement or advance at a speed of between 1800 to 2500 mm/min and, during their displacement on the conveyor belt (2), are irradiated with microwaves at a power of between 35 to 70 Kilowatts for 1.7 to 2.4 minutes. Upon reaching the exit (5) in the tunnel (1), the boxes (3) have a final temperature of between 26.60 to 30.20° F. (−3° C. to −1° C.), which corresponds to the temperature of the final center of the product.

Comparative Results Tests

In order to demonstrate the superior results of the process proposed by the present invention with respect to the processes of the prior art, comparative tests showing these results will be shown below.

Thawing Process in a Controlled Environment Chamber

The salmon thawing process in a controlled environment chamber was carried out with the parameters shown in the following table 1:

TABLE 1
Controlled environment chamber thawing parameters

| | Relative | Product surface | Thermal center | Quantity | Time | Time |
|---|---|---|---|---|---|---|
| Product | humidity | temperature | temperature | Lb | (hours-min) | (min) |
| Whole | 100% | 35.60° F. | 28.40° F. | 12-14 | 2 hours 30 min | 150 min |
| | | (2° C.) | (−2° C.) | | | |
| Fillet | 100% | 35.60° F. | 28.40° F. | 4-5 | 1 hour | 60 min |
| | | (2° C.) | (−2° C.) | | | |

Thawing Process in Room

The salmon thawing process with constant temperature in the room was carried out with the parameters shown in the following table 2:

TABLE 2
Room thawing parameters

| | | Termal | | |
|---|---|---|---|---|
| | Room | center | Quantity | Time |
| Product | temperature | temperature | Lb | (hours) |
| Whole | 46.04° F. | 30.20° F. | 12-14 | 24 hours |
| | (7.8° C.) | (−1° C.) | | |
| Fillet | 46.04° F. | 30.20° F. | 4-5 | 7 hours |
| | (7.8° C.) | (−1° C.) | | |

Thawing Process with Water Bath

The salmon thawing process with a water bath at a constant temperature was carried out with the parameters shown in the following table. 3:

TABLE 3
Water Bath Thawing Parameters

| | | Thermal | | |
|---|---|---|---|---|
| | Water | center | Quantity | Time |
| Product | temperature | temperature | Lb | (hours) |
| Whole | 50° F. | 33.26° F. | 12-14 | 9 hours |
| | (10° C.) | (0.7° C.) | | |
| Fillet | 50° F. | 33.26° F. | 4-5 | 4 hours |
| | (10° C.) | (0.7° C.) | | |

Comparative analysis of weight loss of whole salmon and salmon fillets, according to the type of thawing process applied and according to the industrial facility of the Applicant:

A comparative analysis of the weight loss, after the thawing processes carried out in three processing plants of the Applicant, is shown in tables 4 to 6 below:

TABLE 4
Weight loss of whole salmon per plant

| | | Process with | Process | Water |
|---|---|---|---|---|
| | Microwave | chamber controlled | with room | bath |
| Facility | process | conditions | temperature | process |
| Facility 1 | 0.041% | 0.265% | 0.626% | 1.025% |
| Facility 2 | 0.361% | 0.603% | 0.717% | 1.466% |
| Facility 3 | 0.178% | 0.788% | 0.266% | 0.748% |
| Overall total: | 0.187% | 0.552% | 0.535% | 1.032% |

The microwave thawing process was applied to whole frozen salmon, finding that microwave thawing generates weight losses of 0.187%, which are lower than those generated by the water thawing process, which corresponds to 1.032%.

A certain similarity is observed in the result between the thawing treatments in a chamber under controlled conditions and the thawing treatment at room temperatures for whole salmon (known in the art as HON). This is explained by the similarity of both processes with the difference that the controlled conditions chamber allows the defrosting time to be accelerated by controlling the relative humidity and temperature variables.

TABLE 5
Weight loss of salmon fillets per plant

| | | Process with | Process | Water |
|---|---|---|---|---|
| | Microwave | chamber controlled | with room | bath |
| Facility | process | conditions | temperature | process |
| Facility 1 | 0.145% | 0.614% | 0.427% | 1.215% |
| Facility 2 | 0.156% | 0.131% | 0.338% | 1.363% |
| Facility 3 | 0.108% | 0.372% | 0.329% | 0.643% |
| Overall total: | 0.137% | 0.392% | 0.367% | 1.206% |

The microwave thawing process was applied to salmon fillets with skin (TD) that were frozen by quick freezing in individual packages (IQF), finding that microwave thawing generates weight losses of 0.137%, which are lower than those produced by the process of thawing by water bath that corresponds to 1.206%.

Some similarity is observed in the result between the chamber thawing treatments with controlled conditions and the thawing treatment at room temperatures for frozen skin-on salmon fillets (referred to in the art as TD). This is explained by the similarity of both processes with the difference that the controlled conditions chamber allows the defrosting time to be accelerated by controlling the relative humidity and temperature variables.

TABLE 6
Weight loss of salmon fillets with skin (TD VP) per facility

| | | Process with | Process | Water |
|---|---|---|---|---|
| | Microwave | chamber controlled | with room | bath |
| Facility | process | conditions | temperature | process |
| Facility 1 | 0.962% | 1.509% | 1.022% | 1.204% |
| Facility 2 | 0.435% | 1.578% | 1.665% | 1.140% |
| Facility 3 | 1.199% | 1.673% | 1.140% | 1.280% |
| Overall total: | 0.823% | 1.581% | 1.266% | 1.217% |

In the case of skin-on salmon fillets (TD) that were frozen prior to vacuum sealing (VP), they were thawed with microwaves, resulting in lower losses of 0.823%.

Thawing processes that exceed 37.9° F. (3.3° C.) cannot be carried out due to the growth of anaerobic bacteria, which is regulated by US legislation.

Comparative analysis of color measurement, according to the SalmoFan® scale, of whole salmon and salmon fillets, according to industrial plant:

The salmon subjected to the four thawing processes and from the three plants of the Applicant, were analyzed with the SalmoFan® color scale, which is shown in FIG. 8 as a reference. The result of this comparative analysis is shown in the following table 7:

TABLE 7
Salmofan ® scale fillet color measurement

| | | Fresh fillet | Thawed fillet |
|---|---|---|---|
| | | color | color |
| | | (SalmoFan ® | (SalmoFan ® |
| Thawing process | Facility | scale) | scale) |
| Microwaves | Facility 1 | 26 | 26 |
| | Facility 2 | 25 | 25 |
| | Facility 3 | 25 | 25 |
| Total microwaves | | 25 | 25 |
| Controlled condition | Facility 1 | 26 | 26 |
| chamber | Facility 2 | 24 | 24 |
| | Facility 3 | 25 | 25 |
| Total controlled condition chamber | | 25 | 25 |
| Room temperature | Facility 1 | 26 | 26 |
| | Facility 2 | 24 | 24 |
| | Facility 3 | 25 | 25 |
| Total Room temperature | | 25 | 25 |
| Water bath | Facility 1 | 26 | 26 |
| | Facility 2 | 24 | 24 |
| | Facility 3 | 25 | 25 |

| | | |
|---|---|---|
| Total water bath | 25 | 25 |

The results shown in table 7 indicate that the color parameter in each of the thawing processes is maintained.

Also, it is important to consider that the evaluation of color on the surface of the product was carried out at temperatures above 30.2° F. (−1° C.) to observe the maximum expression of color once the water crystals had dissolved.

Shelf Life Analysis

To carry out the comparative analysis of the shelf life between the thawing processes of the prior art and the process of the present invention, the results of the mesophilic aerobic count tests of frozen skin-on salmon fillets and frozen salmon fillets will be shown. with skin that were frozen prior to vacuum sealing, in the following tables 8 to 10:

TABLE 8
Aerobic mesophilic count in Colony Forming Unit per gram
of product (CFU/g) in salmon fillets with skin (DT)
that were frozen by individual quick freezing (IQF).

| | Fresh | | Controlled | Room | Water |
|---|---|---|---|---|---|
| | salmon | Microwaves | chamber | temperature | bath |
| Day | (UFC/g) | (UFC/g) | (UFC/g) | (UFC/g) | (UFC/g) |
| 0 | 2.540 | 1.153 | 30 | 1.530 | 2.774 |
| 5 | 1.760 | 220 | 93 | 4.140 | 8.000 |
| 10 | 33.600 | 3.173 | 30.440 | 18.593 | 37.930 |
| 15 | 89.267 | 18.067 | 66.933 | 199.000 | 308.000 |
| 17 | 227.333 | 62.000 | 180.533 | 474.000 | 405.000 |
| 19 | 508.667 | 344.667 | 583.333 | 869.000 | 1.252.000 |
| 21 | 1.014.000 | 719.333 | 596.667 | 1.198.667 | 1.460.000 |
| 23 | 2.668.667 | 1.408.000 | 1.713.333 | 4.450.000 | 1.920.000 |

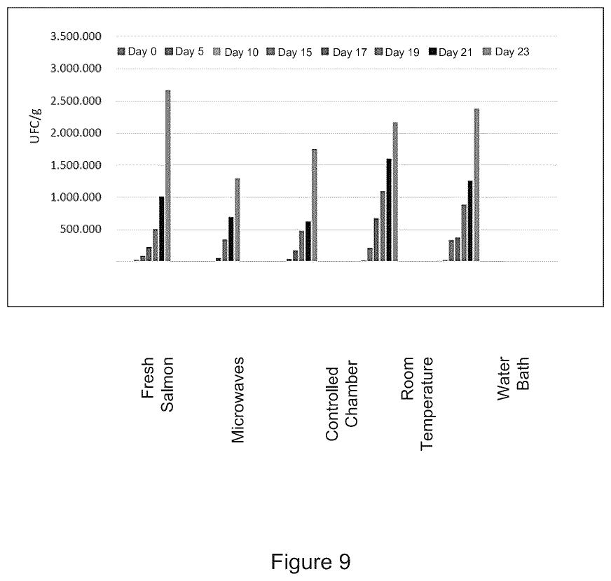

The results shown in Table 8 and FIG. 9 show that microwave-thawed salmon meat has a low propagation rate of mesophilic aerobes, which is lower than the propagation rate of fresh salmon meat.

TABLE 9
Aerobic mesophilic count in Colony Forming Unit per gram of product (CFU/g) in
salmon fillets with skin (TD) that were thawing prior to vacuum sealing (VP).

| | Fresh | | Controlled | Room | Water |
|---|---|---|---|---|---|
| | salmon | Microwaves | chamber | temperature | bath |
| Day | (UFC/g) | (UFC/g) | (UFC/g) | (UFC/g) | (UFC/g) |
| 0 | 2.540 | 340 | 1.780 | 1.670 | 678 |
| 5 | 1.760 | 233 | 380 | 4.247 | 10.970 |
| 10 | 33.600 | 1.087 | 11.233 | 16.280 | 27.470 |
| 15 | 89.267 | 8.250 | 40.533 | 219.00 | 336.000 |
| 17 | 227.333 | 52.533 | 171.733 | 674.667 | 374.000 |
| 19 | 508.667 | 340.667 | 476.667 | 1.094.000 | 886.000 |
| 21 | 1.014.000 | 694.000 | 622.000 | 1.600.000 | 1.256.667 |
| 23 | 2.668.667 | 1.293.500 | 1.746.667 | 2.166.667 | 2.380.000 |

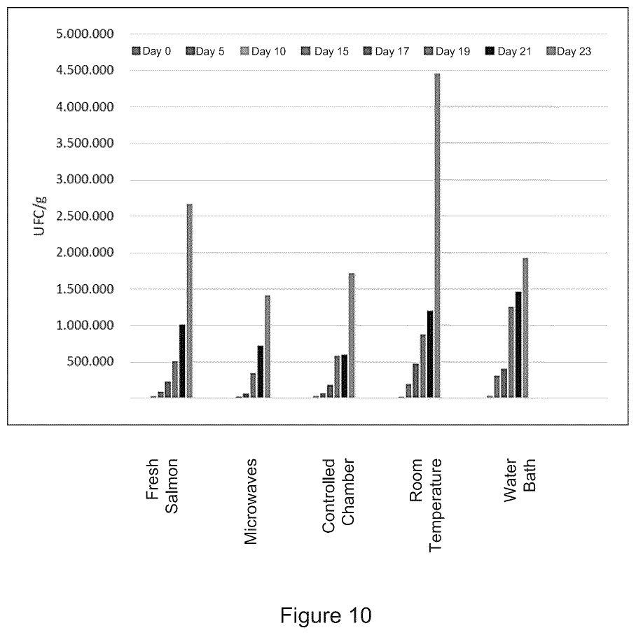

The results shown in Table 9 and FIG. 10 show that microwave-thawed salmon meat has a lower propagation rate of mesophilic aerobes than the propagation rate of fresh salmon meat. This means that the shelf life of microwave-thawed salmon is longer than that of fresh salmon.

TABLE 10
Aerobic mesophilic count in Colony Forming Unit per gram of product
(CFU/g) for fresh TE from HON thawed by the technologies.

| | Fresh | | Controlled | Room | Water |
|---|---|---|---|---|---|
| | salmon | Microwaves | chamber | temperature | bath |
| Day | (UFC/g) | (UFC/g) | (UFC/g) | (UFC/g) | (UFC/g) |
| 0 | 2.540 | 0 | 0 | 6.580 | 400 |
| 5 | 1.760 | 0 | 0 | 3.867 | 780 |
| 10 | 33.600 | 9.327 | 9.973 | 23.147 | 12.320 |
| 15 | 89.267 | 198.667 | 342.667 | 373.000 | 255.000 |
| 17 | 227.333 | 655.333 | 699.333 | 611.000 | 611.000 |
| 19 | 508.667 | 1.072.667 | 1.001.333 | 944.000 | 944.000 |
| 21 | 1.014.000 | 1.323.333 | 1.540.000 | 1.580.000 | 1.580.000 |
| 23 | 2.668.667 | 2.180.000 | 2.153.333 | 2.360.000 | 2.360.000 |

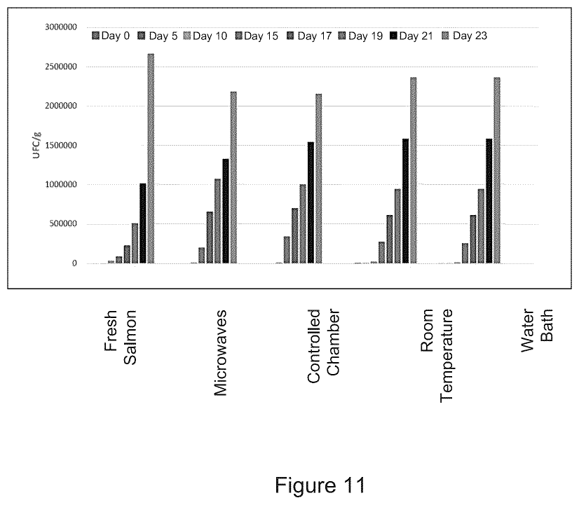

The results shown in Table 10 and FIG. 11 show that microwave-thawed salmon meat has a low propagation rate of mesophilic aerobes, which is lower than the propagation rate of fresh salmon meat.

Dynamic Shrinkage Analysis

Within the parameters that allow the effectiveness of the process of the present invention to be compared with the processes of the prior art, is the dynamic reduction that consists of determining the amount of salmon meat that is lost by dripping. This analysis is shown in Table 11 below:

TABLE 11
Dynamic loss for skin-on (TD) salmon fillets that were frozen
by individual quick freezing (IQF) of 4-5 Lb (1.81 to 2.26 kg).

| Process | 24 Hrs. | 48 Hrs. | 72 Hrs. | 96 Hrs. |
|---|---|---|---|---|
| Microwaves | 0.825% | 1.488% | 2.131% | 2.316% |
| Controlled chamber | 1.177% | 1.984% | 2.857% | 3.043% |
| Room temperature | 0.808% | 1.946% | 2.514% | 2.895% |
| Water bath | 0.862% | 1.966% | 2.568% | 2.945% |

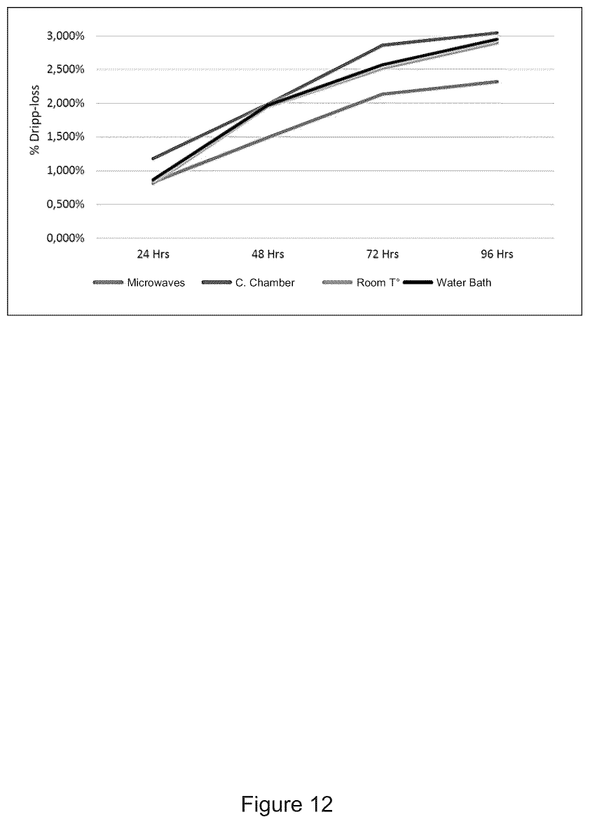

The results shown in table 11 and in FIG. 12 show that the salmon meat has less loss when thawed with the microwave process of the present invention, compared to the processes of the prior art, due to the fact that it presents less loss by drip (drip-loss).

TABLE 12
Dynamic loss for salmon fillets with skin (TD) that were frozen
prior to vacuum sealing (VP) 4-5 Lb (1.81 to 2.26 kg).

| Process | 24 Hrs. | 48 Hrs. | 72 Hrs. | 96 Hrs. |
|---|---|---|---|---|
| Microwaves | 0.862% | 1.632% | 2.298% | 2.494% |
| Controlled chamber | 1.259% | 2.086% | 2.767% | 2.966% |
| Room temperature | 0.853% | 1.982% | 2.560% | 2.948% |
| Water bath | 0.820% | 1.903% | 2.517% | 2.891% |

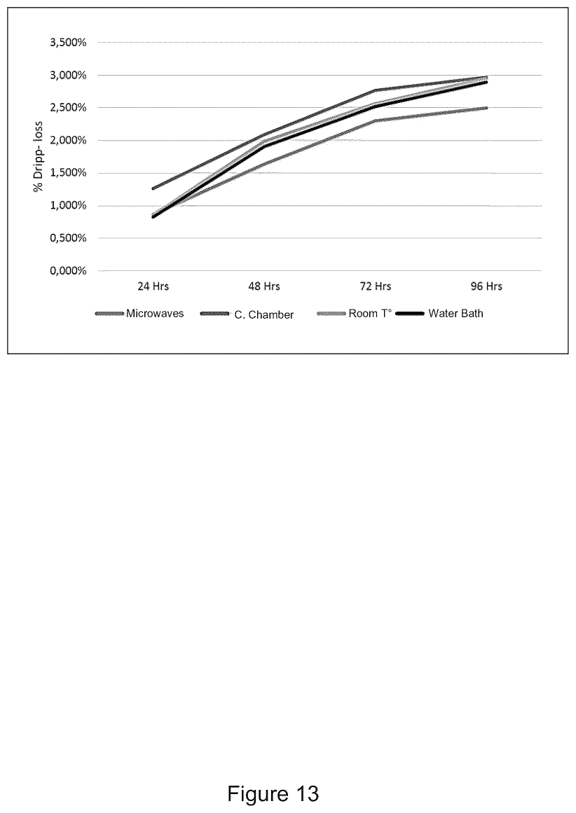

The results shown in table 12 and in FIG. 13 show that the salmon meat has less loss when thawed with the microwave process of the present invention, compared to the processes of the prior art, due to the fact that it presents less loss by drip-loss.

The results shown above demonstrate that the process for thawing whole salmon or filleted salmon according to the present invention is superior to prior art thawing processes, since it is a process that is carried out continuously in a short time, between 1.7 to 2.4 minutes and, where the phenotypic properties of raw salmon are maintained and even improved with this process.

Analysis of the Effect of Microwave Thawing on Nutritional Components Between Fresh Salmon and Thawed Salmon

In the analysis of the salmon thawing process, it was evaluated whether the nutritional characteristics of fresh salmon are the same or different from salmon that has been stored for a few months and thawed by non-thermal microwave treatment.

In general, the moisture content of the salmon sample appeared to be inversely related to the total extractable lipid content. This is shown in the following table 13:

TABLE 13
Total Extractable Lipid Content and Total Moisture
of Fresh and Microwave Thawed Salmon

| Nutrient | Fresh | Microwave thawed |
|---|---|---|
| Lipids (%) | 15.15 ± 0.49 | 11.87 ± 1.60 |
| Humidity (%) | 63.19 ± 0.86 | 66.45 ± 1.63 |

When applying a one-factor ANOVA, it is concluded: The fresh and microwave-thawed salmon did not show significant differences in the lipid content. Even so, an analysis was carried out on the fatty acids that make up the total fat, obtaining the following results, shown in table 14:

TABLE 14
Fatty acid content (% total fatty acids) in
fresh. microwave-thawed Atlantic Salmon

| | | Microwave |
|---|---|---|
| Fatty acid | Fresh | thawing |
| Total saturated fatty acids | 2.46 ± 0.04 | 1.82 ± 0.26 |
| Total monounsaturated fatty acids | 6.87 ± 0.86 | 4.91 ± 0.72 |
| C20:5n3 eicosapentaenoic acid (EPA) | 0.32 ± 0.03 | 0.26 ± 0.01 |
| C22:5w3 docosapentanoic acid (DPA) | 0.16 ± 0.01 | 0.13 ± 0.00 |
| C22:6w3 docoahexaenoic acid (DHA) | 0.46 ± 0.01 | 0.36 ± 0.05 |
| Total polyunsaturated fatty acids | 4.79 ± 0.19 | 3.75 ± 0.49 |
| Total fatty acids identified | 14.12 ± 0.17 | 10.48 ± 1.48 |
| Total Omega 3 | 1.78 ± 0.01 | 1.4 ± 0.170 |
| Total Omega 6 | 2.94 ± 0.32 | 2.36 ± 0.33 |
| n-3/n-6 ratio | 0.61 | 0.59 |

According to the results shown in table 14, it can be concluded:
1. The most abundant fatty acids for fresh fish in the following order: Monounsaturated (49%), Polyunsaturated (34%) and Saturated (17%)
2. The most abundant fatty acids for microwave-thawed fish in the following order: Monounsaturated (47%), Polyunsaturated (36%) and Saturated (17%).
3. For fresh and microwave-thawed salmon Monounsaturated fatty acids are present in the highest amounts and oleic acid (C18:1) predominates.
4. Microwave-thawed fresh salmon did not show significant differences in monounsaturated fatty acid content.
5. For fresh and microwave-thawed salmon, polyunsaturated fatty acids predominate with 18:2n6c-linoleic acid, cis-linolenic acid as the omega-6 fatty acid, and DHA and EPA as the omega-3.
6. Fresh and microwave-thawed salmon showed similar levels of polyunsaturated fatty acids.
7. For fresh and microwave-thawed salmon, saturated fatty acids predominantly palmitic acid (C16:0) and stearic acid (C18:0)
8. Microwave-thawed fresh salmon did not show significant differences in saturated fatty acid content.
9. The results show that the content of omega-3 fatty acids (as % total fatty acids) in fresh and microwave-thawed fish was 13%, respectively, these provided the fatty acids DHA, EPA and DPA.
10. Microwave-thawed fresh salmon showed no significant differences in DHA, EPA and DPA content.
11. Fresh as well as frozen and microwave-thawed fish is a good source of omega-3 fatty acids.
12. The types and levels of fatty acids found in fish vary by species, age, size, stage of reproduction, season, geographic location, and diet.

TABLE 15
Total content of Astaxanthin. Vitamin D and
E of fresh and microwave-thawed salmon.

| Nutrient | Fresh | Microwave thawing |
|---|---|---|
| Astaxanthin (mg/Kg) | 6.9 ± 0.00 | 6.85 ± 1.06 |
| Vitamin D3 (μ/100 g) | 8.73 ± 3.92 | 8.20 ± 2.52 |
| Vitamin E (μ/100 g) | 57.0 ± 0.00 | 42.55 ± 5.162 |

The results for microwave-thawed fresh salmon are within the nutritional values for the Salmo Salar species, according to sources such as the United States Food and Drug Administration (FDA) and the World Food and Agriculture Organization (FAO).

The patent or application file contains at least one drawing executed in color. Copies of this patent or patent application publication with color drawings will be provided by the office upon request and payment of the necessary fee.

1. A continuous process to thaw salmon meat, salmon fillets or gutted whole salmon, by means of microwaves, where the salmon meat, salmon fillets or gutted whole salmon, once thawed, are at least identical to salmon meat, salmon fillets or gutted whole salmon, which have not been previously frozen, where said process is carried out in a thawing tunnel that has an entrance and an exit, between which a conveyor belt is located, on which are deposited boxes containing the salmon meat, salmon fillets or gutted whole salmon, wherein the process comprises the steps of:
(a) place said boxes containing the salmon meat, salmon fillets or gutted whole salmon into the tunnel, wherein the thermal center of the salmon meat, salmon fillets or gutted whole salmon is at an initial temperature between 3.2 to 12.20° F. (−16° C. and −11° C.), wherein the salmon meat, salmon fillets or gutted whole salmon enters the tunnel in the boxes, and wherein said boxes weigh between 22 and 66 lbs (10 and 30 kg);
(b) advance the boxes containing the salmon meat, salmon fillets or gutted whole salmon towards the interior of the tunnel at a speed between 1,800 and 2,100 mm/min;
(c) irradiating the boxes containing the salmon meat, salmon fillets or gutted whole salmon with microwaves at a power of between 35 to 70 Kilowatts for 1.7 to 2 minutes, until the temperature of the thermal center of the salmon meat, salmon fillets or gutted whole salmon is between 26.60 to 30.20° F. (−3° C. to −1° C.).

2.-5. (canceled)
